(19) United States
(12) Patent Application Publication
(10) Pub. No.: US 2007/0222954 A1
(43) Pub. Date: Sep. 27, 2007

(54) Image Display Unit

(75) Inventor: Tomohiko Hattori, ogaki-shi Gifu (JP)

Correspondence Address: POSZ LAW GROUP, PLC, 12040 SOUTH LAKES DRIVE, SUITE 101, RESTON, VA, 20191, US

(73) Assignees: SEA PHONE CO., LTD., OGAKI-SHI, GIFU (JP); ARISAWA MFG. CO., LTD., JOETSU-SHI, NIGATA (JP)

(21) Appl. No.: 11/596,216

(22) PCT Filed: May 24, 2005
(86) PCT No.: PCT/JP05/09452

§ 371 Date: Nov. 14, 2006

(30) Foreign Application Priority Data
May 28, 2004 (JP) 2004-158497

(51) Int. Cl. G03B 21/00

(52) U.S. Cl. 353/122

(57) ABSTRACT

An image display unit provided with an image focusing member for focusing an image of a point light source on a pupil of an observer as means for projecting images displayed on a transmission type image display plate, which is capable of following the movement of the observer with a simple construction.

A point light source array 12 composed of a large number of point light sources 120 which are arranged dispersedly in a plane direction in an array is provided such that the point light source 120 to be focused on the pupil shifts to its adjacent point light source 120 even when the observer moves. The ratio of the interval between adjacent point light sources 120 to the distance from the point light source array 12 to an image focusing member 13 is determined to become equal to the ratio of the diameter of a pupil of a person to the distance from the image focusing member 13 to the image focusing position of the point light source 120, thereby preventing the existence of an observation disabling area while avoiding the viewing of superimposed images.

### TECHNICAL FIELD

The present invention relates to an image display unit, and more particularly, to an image display unit for projecting images appearing on a transmission type image display unit.

### BACKGROUND ART

The image display units have been widely used in personal computers, home televisions, cellular phones, amusement machines, etc., and various image display units displaying images with high resolutions have been proposed. However, in order to view images displayed with these image display units, a considerable number of observers must correct their eyesight with glasses, etc. And small letters have become difficult to view with aging. Thus, the sharpness of images depends on observer's eyesight. In addition, the continuous viewing of screens over a long time causes the increment of eyestrain. Eyesight has also lowered. On the other hand, in one example of the image display units, light emitted from a point light source is converged on an observer's pupil with a lens to project images on his retina directly, so that he can view the projected images without accommodation of his eye.

In order to bring the position of the observer's pupil into the image forming position of the point light source, Patent document 1 discloses the technique of detecting and analyzing the position of the observer's pupil with a camera, etc. and shifting the position of the point light source to adjust the image forming position of the point light source to the observer's pupil according to the movement of the observer.

Patent document 1: Publication of Japanese unexamined patent application No. 2002-318365

### DISCLOSURE OF THE INVENTION

### Problem to be Solved with the Invention

However, the technique of Patent document 1 requires means for specifying the position of the observer's pupil and varying the point light output position so as to become complicated.

The present invention has been made in view of the above-described circumstances, and has an object of providing an image display unit capable of displaying images having high sharpness with a simple construction according to the movement of an observer.

### MEANS FOR SOLVING THE PROBLEMS

The invention disclosed in claim 1 is an image display unit provided with an image focusing member adapted to focus an image of a point light source in a predetermined position as means for projecting an image displayed on a transmission type image display plate. By dispersing a large number of point light sources in a plane direction, a point light source array which is formed in an array is provided, and the ratio of the interval between adjacent point light sources to the distance from the point light source array to the above-described image focusing member is set so as to be approximately equal to the ratio of the diameter of a person's pupil to the distance from the above-described image focusing member to the above-described predetermined position.

FIG. 1 and FIG. 2 respectively show the inventive concept of claim 1. Point light sources 120 of a point light source array 12 form images in predetermined positions F0 through F6 by means of image focusing members 13 and 13A. The predetermined positions F0 through F6 are located on an imaginary plane facing the image display unit, but dispersed so as to correspond to the number of the point light sources 120. These drawings show the state when the observer faces the image display unit of the present invention such that a pupil of an eyeball 2 of the observer is located in the position F0 out of the predetermined positions F0 through F6. In this case, light emitted from the point light sources 120 enters a crystalline lens 21 from the pupil of the eyeball 2, and an image D displayed on the transmission type image display plate 11 is projected on a retina 22. Light from the point light sources 120 is converged in substantially one point on the position of the crystalline lens 21 of the eyeball 2 so that the resolution of the image I projected on the retina 22 does not depend on the image focusing ability of the crystalline lens 21. Consequently, the sharpness of the image I is high. Furthermore, the tension of a ciliary body is moderated to decrease eyestrain, which would be caused by a long time viewing of images.

In addition, the ratio of the interval between adjacent point light sources 120 to the distance from the point light source array 12 to the image focusing members 13,13A is set so as to become equal to the ratio of the diameter of a pupil of a person to the distance from the image focusing members 13, 13A to the above-described predetermined position F0. With this arrangement, with respect to image focusing member elements 13 and 130 of the image focusing members 13 and 13A, which independently achieve the image focusing action, the interval between adjacent images of the point light sources 120, which are focused in the predetermined position F0, becomes equal to the diameter of the pupil so that the point light source which forms the image in the position of the observer's pupil simultaneously is only one point light source 120. Therefore, the observer is prevented from viewing the displayed image D as a superimposed image. In addition, as the position of the observer's pupil shifts from the position F1 to the position F6 by way of the position F2 through F6 due to the movement of the observer, the point light source 120 of which the image is focused on the observer's pupil moves to the adjacent point light source 120 in sequence. When light from a certain point light source 120 is off his pupil, light from the point light source 120 adjacent to the above-described point light source 120 enters his pupil immediately. Consequently, the observable position is not limited to one position, and there continues the range where the observer can view the displayed images without forming the observing position in which the displayed images are impossible to be observed so that no unpleasant feeling is given to the observer. Thus, this arrangement can achieve the operation substantially equivalent to the operation that the point light source moves following the movement of the observer so as to focus an image projected by the point light source on the observer's pupil.

In the invention disclosed in claim 2, the image focusing member in the construction of the invention of claim 1 is arranged in an array.

FIG. 2 shows the inventive concept of claim 2. In FIG. 1, the element of the image focusing member 13, which independently achieves the image focusing operation, is single, whereas in the image focusing member 13A of FIG. 2, the elements 130, each independently achieving the image focusing operation, are plural and arranged in an array. With this arrangement, the operation equivalent to that of the invention of claim 1 is achieved, and the image focusing member 13A is made thin, whereby the entire image display unit can be made compact.

In the invention of claim 3, the construction of the invention of claim 1 or 2 is further provided with driving means for driving the point light source array or the image focusing member to enable the adjustment of the distance from the point light source array to the image focusing member.

By changing the distance from the point light source array to the image focusing member, the image focusing position of the point light source can be made away from or close to the image display unit. With this arrangement, the position suitable to the observation can be freely extended frontward and rearward.

In the invention of claim 4, the point light source array of the construction of the invention of one of claim 1 through 3 is composed of light sources, each being capable of performing on-off changeover, independently, and by reducing substantially one part of the point light sources, the interval between the adjacent point light sources can be adjusted.

As the ratio of the diameter of the observer's pupil to the distance from the image focusing member to the predetermined position varies, the ratio of the interval between the adjacent point light sources to the distance from the point light source array to the image focusing member can be changed so as to become equal to the above-described ratio. With this arrangement, where the observer moves frontward and rearward by a long distance, the observer can be prevented from viewing a superimposed image. In addition, the observable range for the observer can be enlarged frontward and rearward.

### BEST MODE FOR CARRYING OUT THE INVENTION

### First Embodiment

A first embodiment of an image display unit in accordance with the present invention is shown in FIG. 3. The image display unit includes a multi-lens 5 as an image focusing member, a liquid crystal display plate 3 as a transmission type image display plate and a point light source array 4.

The point light source array 4 is provided with a screen 42 of which a substrate has a predetermined design including light source shielding parts and light source transmitting parts on the observer's side of a backlight 41 used in a general liquid crystal display unit, and emits light from a point light source 401 toward an observer 6. The multi-lens 5 is provided on the liquid crystal plate 3 on the side of the point light source 401 to converge the light emitted from the point light source array 4 in the position of a pupil of the observer 6 and focus images of the point light source 401 in the position of the pupil. The liquid crystal display plate 3 projects images on a retina of the observer 6 with the point light source 401 as a backlight. The screen 42 and the point light source 401 will be explained later.

A multi-Fresnel lens composed of Fresnel lenses, each being an image focusing element achieving the image focusing operation independently, which are arranged in an array, is used as an example of the multi-lens 5. With this arrangement, the lens thickness is reduced, and consequently, the entire unit can be made thin and small. The multi-lens 5 may be composed of a convex lens array which includes convex lenses arranged in an array. In FIG. 3, the convex lens array is shown as the multi-lens 5, but the multi-lens 5 is not limited to this arrangement. This can be applied in the following embodiments, similarly.

A liquid crystal plate provided in a general liquid crystal display unit, which is composed of a polarizer, a glass board having transparent electrodes, a liquid crystal material, etc., can be used as the liquid crystal display plate 3.

The screen 42 and the point light source 401 will be explained. FIG. 4(A) is a view taken in the direction of IV in FIG. 3, and shows the point light source array 4 seen from the side of the multi-lens 5. The screen 42 may be secured to a surface of the backlight 41, which faces the observer, with a bonding agent, etc. ex., and the above-described design of the screen 42 may be formed with the printing method, etc.

In the present embodiment, the above-described design is provided by forming a large number of minute hole patterns 421 as the light source transmitting parts on a black base as the light source shielding part into a lattice configuration. FIG. 4(B) shows one part of the design, and the hole patterns 421 are located such that intervals between adjacent hole patterns 421 are equal to each other. Therefore, in the point light source array 4, a large number of point light sources 401 are dispersedly arranged on a plane, and the intervals between adjacent point light sources 401 are constant.

The intervals between the adjacent hole patterns 421, that is the intervals between the adjacent point light sources 401, are determined, as follows. In this case, the present image display unit to be applied to a display of a personal computer will be explained. The distance between the multi-lens 5 and the observer 6 has been supposed to be 500 mm. And the typical value of the diameter of the person's pupil is 7 mm. On the other hand, assuming that the focal length of the multi-lens 5 is 100 mm, the distance z between the point light source array 4 and the multi-lens 5 becomes 125 mm from the equation (1/100)=(1/z)+(1/500) in order that the point light source 401 forms images in the position of the observer 6. At this time, in order to make the ratio of the interval between the adjacent point light sources 401 to the distance from the point light source array 4 to the multi-lens 5 equal to the ratio of the diameter of the person's pupil to the distance from the multi-lens 5 to the observer 6, x that is the interval between the adjacent holes 421 is determined to 1.75 mm from the equation of x/125=7/500.

This arrangement can achieve the operation substantially equivalent to the operation that the point light source moves following the movement of the observer such that the image of the point light source is focused on the observer's pupil.

### Second Embodiment

A second embodiment of an image display unit in accordance with the present invention is shown in FIG. 5. In the present embodiment, the image display unit is applied to the image display unit for a cellular phone. A multi-lens 5A and a point light source array 4A are disposed behind a liquid crystal display plate 3A in this order. The multi-lens 5A may be composed of a multi-Fresnel lens which can be made thin, in view of the portability and operatability of cellular phones.

The point light source array 4A is shown in FIG. 6. The point light source array 4A is composed of so-called organic EL elements. Metallic electrode layers 44 and transparent electrode layers 45 are provided on surfaces of a glass board (not shown) while sandwiching a light-emitting layer 43 of organic substances therebetween, and many metallic electrode layers 44 and many transparent electrode layers 45, each being formed into a thin strip-shaped configuration, are arranged in a width direction of the glass board with a predetermined pitch. The metallic electrode layers 44 and the transparent electrode layers 45 extend in directions intersecting perpendicularly to each other to provide a matrix wiring. When an electric current is supplied from the metallic electrode layers 44 and the transparent electrode layers 45, light-emitting parts appear in the light-emitting layer 43 in the positions where the metallic electrode layers 44 and the transparent electrode layers 45 intersect each other to form a large number of point light sources 401A in lattice-shaped positions. Accordingly, the point light source array 4A of the present embodiment has the arrangement that a large number of point light sources are dispersedly arranged on a plane, similarly to the first embodiment. In this case, the interval between the adjacent point light sources 401A is determined with a pitch of the metallic electrode layers 44 and the transparent electrode layers 45.

In the case of the cellular phones, the distance between the multi-lens 5A and the observer 6 is supposed to be 300 mm. This is the distance of distinct vision. And the distance between the point light source array 4A and the multi-lens 5A is determined to 8 mm in view of the portability and the operatability of the cellular phones. In this case, the multi-lens 5A is composed to have the focal distance f of 7.8 mm, which is determined from the equation (1/f)=(1/8)+(1/300).

In this case, in order to make the ratio of the interval between the adjacent point light sources 401A to the distance from the point light source array 4A to the multi-lens 5A equal to the ratio of the diameter of the person's pupil to the distance from the multi-lens 5A to the observer 6, x that is the interval between the adjacent point light sources 401A is determined to 0.187 mm from the equation of x/8=7/300.

This arrangement can achieve the operation substantially equivalent to the operation that the point light source moves following the movement of the observer such that the image of the point light source is focused on the observer's pupil.

### Third Embodiment

An image display unit of the present embodiment is shown in FIG. 7. The convenience of the second embodiment in which the present invention is applied to the cellular phone is further improved. An actuator 7 is provided as the driving means for elongating and contracting the distance between the multi-lens 5A and the point light source array 4A in facing directions, and accordingly, the distance between the multi-lens 5A and the point light source array 4A is adjustable. For example, a piezostack of which the elongating amount and the contracting amount vary with the piezoelectric operation according to the charging amount can be used as the actuator 7.

And the point light source array 4A is arranged such that only the point light source 401A located in a predetermined position can be lighted up with a driving circuit 83, whereby the number of the point light sources 401A can be reduced substantially. The point light sources 401A to be on and the point light sources 401A to be off are determined such that the point light sources 401A to be on are arranged at equal intervals longitudinally and transversely, whereby the point light sources 401A to be on are uniformly arranged in the plane irrespective of the reduction of the point light sources 401A. In this case, the point light source array 4A can adopt any system out of the passive matrix system and the active matrix system.

These actuator 7 and point light source array 4A are controlled with a control section 81. The control section 81 outputs control signals to both the driving circuit 82 of the actuator 7 and the driving circuit 83 of the point light source array 4A and consequently, the distance between the multi-lens 5A and the point light source array 4A, and the interval between the adjacent point light sources 401A in the point light source array 4A can be adjusted simultaneously.

A CCD camera 84 is arranged in the vicinity of the liquid crystal display plate 3A so as to face the observer, similarly to the liquid crystal display plate 3A, for taking photographs of the observer who operates a camera cellular phone. Output signals from the CCD camera 84 are input to the control section 81 to detect the distance between the camera cellular phone and the observer, that is the distance between the multi-lens 5A and the observer, based on observer's images. The actuator 7 is controlled such that as the observer approaches the image display unit, namely, the multi-lens 5A, the distance between the multi-lens 5A and the point light source array 4A is enlarged. The operating amount of the actuator 7 is determined to satisfy the equation of (1/f)=(1/z)+(1/Z) in which f is the focal distance, z is the interval between the multi-lens 5A and the point light source array 4A and Z is the detected distance between the multi-lens 5A and the observer. In addition, the point light source array 4A is controlled so as to reduce the number of the point light sources 401A of the point light source array 4A. As the number of the point light sources 401A is reduced, the density thereof decreases and the interval between adjacent point light sources 401A is enlarged. At this time, x that is the interval between the adjacent point light sources 401A is determined to satisfy the equation of x/z=diameter of pupil (7 mm)/Z

With this arrangement, even where the distance between the observer and the image display unit varies, the adjustment is carried out to focus images of the point light source on the pupil of the observer, and to further increase the density of the point light sources as long as no double image is displayed on the liquid crystal display plate 3, which is viewed by the observer, and consequently, the observable range by the observer is enlarged frontward and rearward, whereby a much convenient image display unit is obtained.

### Fourth Embodiment

FIG. 8 shows a fourth embodiment of the image display unit in accordance with the present invention. The image focusing member of the first embodiment is replaced with another image focusing member. This another image focusing member includes a tandem lens 5B consisting of a large diameter lens 5a and a multi-lens 5b, and the large diameter lens 5a is arranged on the side of the liquid crystal display plate 3, whereas the multi-lens 5b is arranged on the side of the point light source array 4. In this case, where the focal distance of the large diameter lens 5a, and the focal distance of the multi-lens 5b are determined to f1 and f2, respectively, and the interval between the multi-lens 5b and the point light source array 4 are determined to f2, the position located at a distance f1 from the large diameter lens 5a corresponds to the image focusing position of the point light source 401 (see FIG. 4(B)) of the point light source array 4.

As described above, the image focusing member adapted to focus images of the point light source may be composed of a combination of a plurality of lenses. In the example shown, the large diameter lens 5a is located on the side of the multi-lens 5b behind the liquid crystal display plate 3, but the large diameter lens 5a may be located on the side opposite to the multi-lens 5b while sandwiching the liquid crystal display plate 3 therebetween.

And a single large diameter lens other than the multi-lens used in the fist through third embodiments, and the combination of the multi-lens with the large diameter lens, which was used in the fourth embodiment, will do. In addition, not only refraction type image focusing members but also reflection type image focusing members such as concave mirrors or Fresnel concave mirrors may be used. Furthermore, diffraction type image focusing members such as holograms will do.

And the present invention can be applied to not only image display units for displaying plane images but also image display units for displaying stereoscopic images provided that transmission type image display plates are used as the image projecting means.

In addition, the present invention can be applied to not only the units such as personal computers and cellular phones, in which transmission type image display plates have been previously assembled, but also the units such as schaukasten, in which X ray films as the transmission type image display plates are set upon using the units.

And the present invention is characterized in that the ratio of the interval between adjacent point light sources to the distance from the point light source array to the image focusing member is determined to become equal to the ratio of the diameter of the person's pupil to the distance from the image focusing member to the image focusing position of the point light source. However, if the ratio of the interval between adjacent point light sources to the distance from the point light source array to the image focusing member is greater than the ratio of the diameter of the person's pupil to the distance from the image focusing member to the image focusing position of the point light source, double images can be prevented from being projected on observers so that the above described “equal” cases include not only the cases that the above-described both ratios are strictly the same with each other, but also the cases that the ratio of the interval between adjacent point light sources to the distance from the point light source array to the image focusing member is greater than the ratio of the diameter of the person's pupil to the distance from the image focusing member to the image focusing position of the point light sources provided that the observation position disabling the observer's viewing of displayed images does not exist substantially, and unpleasant feeling is not given to the observer.

### BRIEF DESCRIPTION OF DRAWINGS

FIG. 1 is a first schematic diagram of an image display unit in accordance with the present invention.

FIG. 2 is a second schematic diagram of an image display unit in accordance with the present invention.

FIG. 3 is a view showing a side of a main part of a first embodiment of an image display unit in accordance with the present invention.

FIG. 4(A) is a view taken in the direction of IV in FIG. 3, and FIG. 4(B) is an enlarged view of one part of FIG. 4(A).

FIG. 5 is a view showing a side of a main part of a second embodiment of an image display unit in accordance with the present invention.

FIG. 6 is a perspective view of a member composing the above-described image display unit.

FIG. 7 is a view showing a side of a main part of a third embodiment of an image display unit in accordance with the present invention along with an electric arrangement thereof.

FIG. 8 is a view showing a side of a main part of a fourth embodiment of an image display unit in accordance with the present invention.

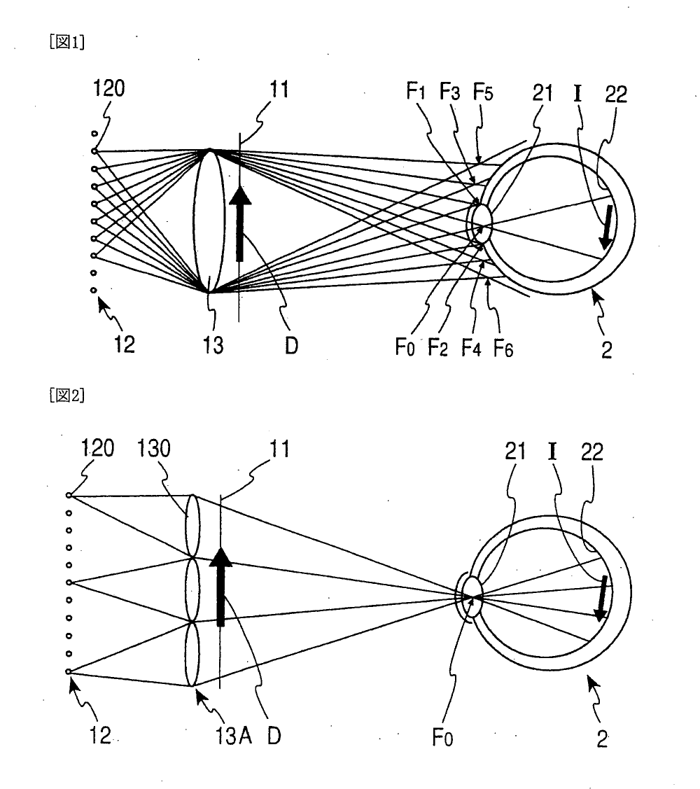

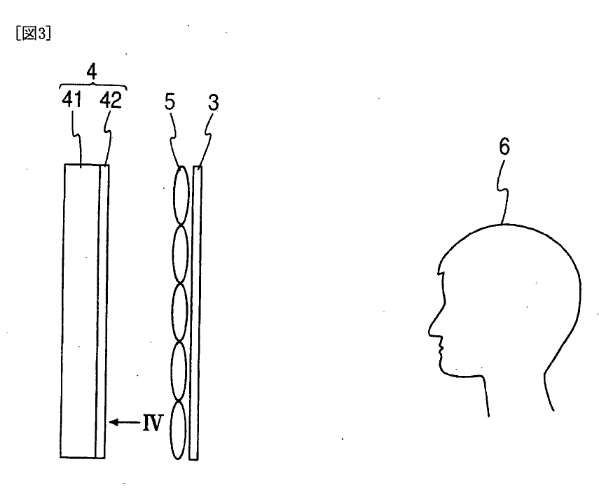

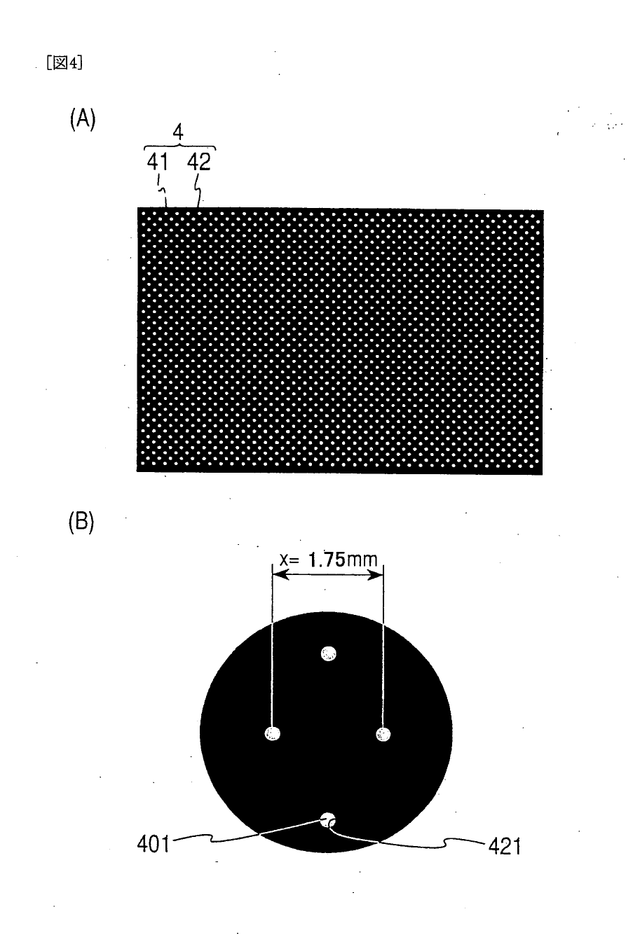

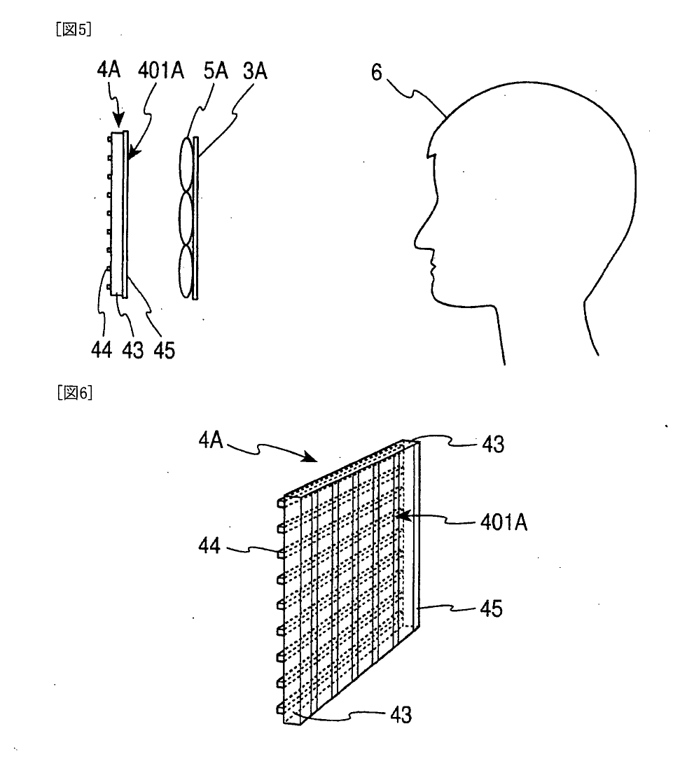

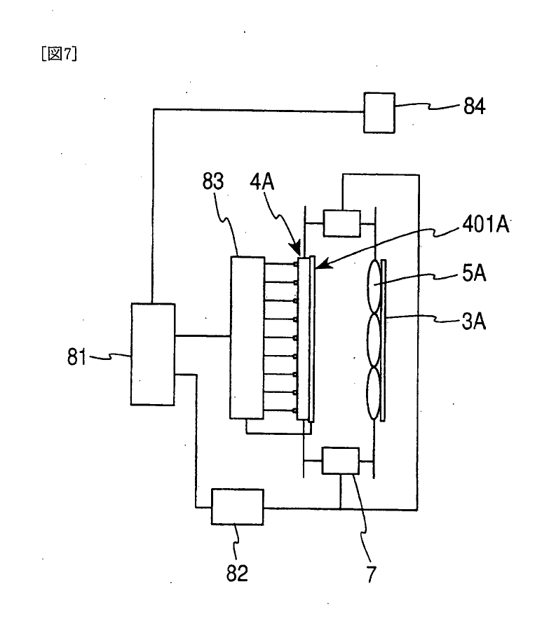

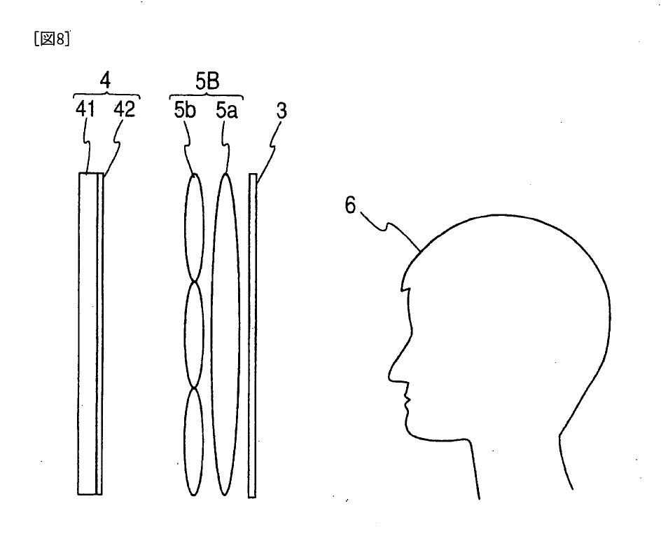

### EXPLANATION OF REFERENCE NUMBER

11 transmission type image display plate
12 point light source array
120 point light source
13, 13A image focusing member
3 liquid crystal display plate (transmission type image display plate)
4,4A point light source array
401,401A point light source
5, 5A, 5b multi-lens (image focusing member)
6 observer
7 actuator (driving means)

1. An image display unit provided with an image focusing member for focusing an image of a point light source in a predetermined position as means for projecting images displayed on a transmission type image display plate, wherein a large number of said point light source are arranged dispersedly in a plane direction in an array to provide a point light source array, and the ratio of the interval between adjacent point light sources to the distance from said point light source array to said image focusing member is determined so as to become approximately equal to the ratio of the diameter of a pupil of a person to the distance from said image focusing member to said predetermined position.

2. An image display unit according to claim 1, wherein said image focusing member is arranged in an array.

3. An image display unit according to claim 1 or 2, wherein driving means for driving said point light source array or said image focusing member is further provided to enable the adjustment of the distance from said point light source array to said image focusing member.

4. An image display unit according to one of claims 1 through 3, wherein said point light source array is composed of light sources, each being capable of performing on-off changeover, independently, and by reducing substantially one part of the point light sources, the interval between adjacent point light sources can be adjusted.
